(19) United States
(12) Patent Application Publication
(10) Pub. No.: US 2018/0306112 A1
(43) Pub. Date: Oct. 25, 2018

(54) System and Method for Regulating Flow in Turbomachines

(71) Applicant: General Electric Company, Schenectady, NY (US)

(72) Inventors: Bradly Aaron Kippel, Greenville, SC (US); Christopher Conrad Frese, Greer, SC (US)

(21) Appl. No.: 15/492,505

(22) Filed: Apr. 20, 2017

(51) Int. Cl. F02C 7/057; F02C 7/042; F01D 17/02

(52) U.S. Cl. CPC F02C 7/057; F02C 7/042; F05D 2270/303; F05D 2270/11; F01D 17/02

(57) ABSTRACT

The present disclosure is directed to a system for regulating a flow of air into a turbomachine. The system includes an inlet section of the turbomachine and a damper having an actuator and a restriction. The damper is positioned within the inlet section and operable to regulate the flow of air into the turbomachine based on a position of the restriction. The system also includes a controller communicatively coupled to the damper. The controller is configured to control the position of the restriction to regulate the flow of air into the turbomachine based on a current operating condition of the turbomachine.

### FIELD

The present disclosure generally relates to turbomachines. More particularly, the present disclosure relates systems and methods for regulating the flow of air into turbomachines.

### BACKGROUND

A gas turbine engine generally includes an inlet section, a compressor section, a combustion section, a turbine section, and an exhaust section. Air enters the gas turbine engine through the inlet section. The compressor section progressively increases the pressure of the air and supplies this compressed air to the combustion section. The compressed air and a fuel (e.g., natural gas) mix within the combustion section and burn in a combustion chamber to generate high pressure and high temperature combustion gases. The combustion gases flow from the combustion section into the turbine section where they expand to produce work. For example, expansion of the combustion gases in the turbine section may rotate a rotor shaft connected to a generator to produce electricity. The combustion gases then exit the gas turbine via the exhaust section.

In some instances, the inlet section may include one or more weather hoods. More specifically, the weather hoods cause the air ingested by the gas turbine engine to flow upward as it enters the inlet section. This may reduce the amount of rain, snow, and other precipitation entering the gas turbine engine. Unfortunately, however, the upward flow reduces the efficiency of the gas turbine engine when precipitation is not present because the directional change in airflow results in a pressure loss.

### BRIEF DESCRIPTION

Aspects and advantages of the technology will be set forth in part in the following description, or may be obvious from the description, or may be learned through practice of the technology.

In one embodiment, the present disclosure is directed to a system for regulating a flow of air into a turbomachine. The system includes an inlet section of the turbomachine and a damper having an actuator and a restriction. The damper is positioned within the inlet section and operable to regulate the flow of air into the turbomachine based on a position of the restriction. The system also includes a controller communicatively coupled to the damper. The controller is configured to control the position of the restriction to regulate the flow of air into the turbomachine based on a current operating condition of the turbomachine.

In another embodiment, the present disclosure is directed to a method for regulating a flow of air into a turbomachine. The method includes controlling, with a controller, a position of a restriction of a damper positioned within an inlet section of the turbomachine to regulate the flow of air into the turbomachine based on a current operating condition of the turbomachine. The damper is communicatively coupled to the controller and operable to regulate the flow of air into the turbomachine based on the position of the restriction.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 is a schematic view of an exemplary gas turbine engine in accordance with embodiments of the present disclosure;

FIG. 2 is a side view of an exemplary inlet section of the gas turbine engine in accordance with embodiments of the present disclosure;

FIG. 3 is a side view of an exemplary damper in accordance with embodiments of the present disclosure;

FIG. 4 is schematic view of a system for regulating a flow of air into a gas turbine engine in accordance with embodiments of the present disclosure;

FIG. 5 is a side view of the damper, illustrating a restriction in a self-cleaning position in accordance with embodiments of the present disclosure;

FIG. 6 is a side view of the damper, illustrating a restriction in a weather protection position in accordance with embodiments of the present disclosure;

FIG. 7 is a side view of the damper, illustrating a restriction in a turndown position in accordance with embodiments of the present disclosure;

FIG. 8 is a side view of the damper, illustrating a restriction in a shutdown position in accordance with embodiments of the present disclosure; and

FIG. 9 is flow chart illustrating a method for regulating a flow of air into a gas turbine engine in accordance with embodiments of the present disclosure.

Repeat use of reference characters in the present specification and drawings is intended to represent the same or analogous features or elements of the present technology.

### DETAILED DESCRIPTION

Reference will now be made in detail to present embodiments of the technology, one or more examples of which are illustrated in the accompanying drawings. The detailed description uses numerical and letter designations to refer to features in the drawings. Like or similar designations in the drawings and description have been used to refer to like or similar parts of the technology. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

Each example is provided by way of explanation of the technology, not limitation of the technology. In fact, it will be apparent to those skilled in the art that modifications and variations can be made in the present technology without departing from the scope or spirit thereof. For instance, features illustrated or described as part of one embodiment may be used on another embodiment to yield a still further embodiment. Thus, it is intended that the present technology covers such modifications and variations as come within the scope of the appended claims and their equivalents.

Although an industrial or land-based gas turbine is shown and described herein, the present technology as shown and described herein is not limited to a land-based and/or industrial gas turbine unless otherwise specified in the claims. For example, the technology as described herein may be used in any type of turbomachine including, but not limited to, aviation gas turbines (e.g., turbofans, etc.), steam turbines, and marine gas turbines.

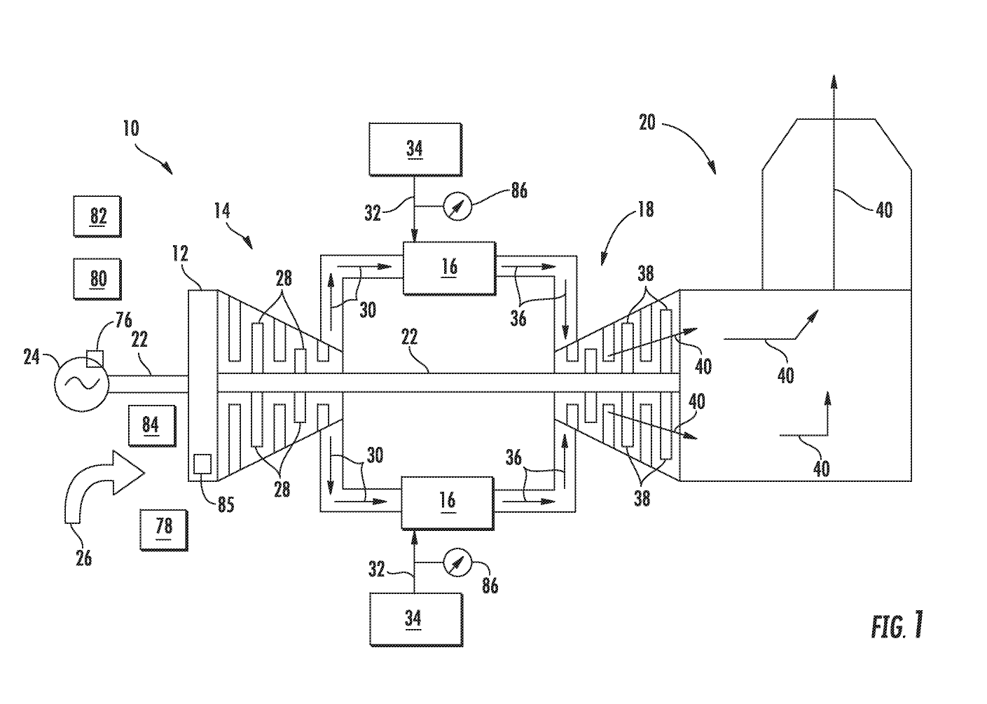

Now referring to the drawings, wherein identical numerals indicate the same elements throughout the figures, FIG. 1 schematically illustrates an exemplary gas turbine engine 10. As depicted therein, the gas turbine engine 10 includes an inlet section 12, a compressor 14, one or more combustors 16, a turbine 18, and an exhaust section 20. The compressor 14 and the turbine 18 may be coupled by a shaft 22, which may be a single shaft or a plurality of shaft segments coupled together. The shaft 22 may also couple the turbine 18 to a generator 24.

During operation, the gas turbine engine 10 produces mechanical rotational energy, which may be used to drive the generator 24. More specifically, air 26 enters the inlet section 12 of the gas turbine engine 10. From the inlet section 12, the air 26 flows into the compressor 14, where one or more rows of compressor rotor blades 28 progressively compress the air 26 to provide compressed air 30 to each of the combustors 16. The compressed air 30 in the combustors 16 mixes with a fuel 32 (e.g., natural gas) supplied by a fuel supply 34. The resulting fuel-air mixture burns in the combustors 16 to produce high temperature and high pressure combustion gases 36. From the combustors 16, the combustion gases 36 flow through the turbine 18, where one or more rows of turbine rotor blades 38 extract kinetic and/or thermal energy therefrom. This energy extraction rotates the shaft 22, thereby creating mechanical rotational energy for powering the compressor 14 and/or the generator 24. The combustion gases 36 exit the gas turbine engine 10 through the exhaust section 20 as exhaust gases 40.

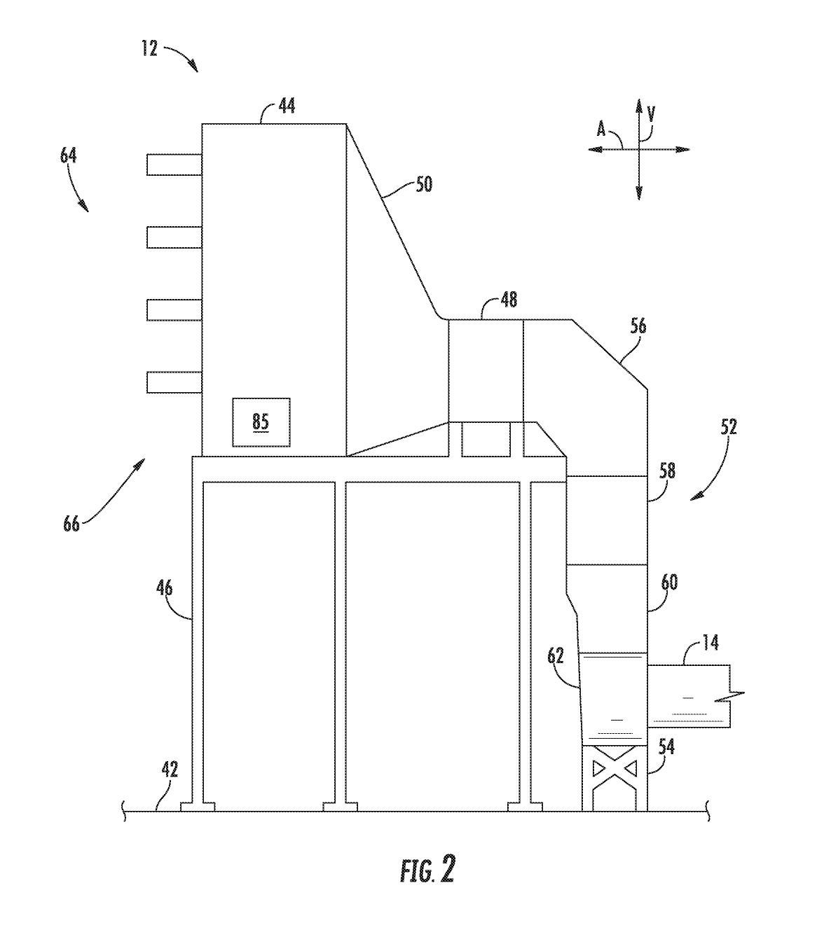

FIG. 2 illustrates an exemplary embodiment of the inlet section 12. As shown, the inlet section 12 couples to a base surface 42, which may be the ground, a power plant floor, a building roof, or any other suitable equipment baseline. In this respect, the inlet section 12 defines a vertical direction V and an axial direction A. Specifically, the vertical direction V generally extends orthogonal to the base surface 42. The axial direction A generally extends orthogonal to the vertical direction V and parallel to the base surface 42.

The inlet section 12 may include a filter housing 44. In particular, the filter housing 44 may include various filters, screens, cooling coils, moisture separators, evaporative coolers, heating systems, and/or other devices to purify and otherwise condition the air 26 entering the gas turbine engine 10. The filter housing 44 may be positioned vertically above the base surface 42 to reduce the amount of dust or other particles that enter the inlet section 12 during operation of the gas turbine engine 10. In this respect, a first support structure 46 may support the filter housing 44 above the base surface 42.

In the embodiment shown in FIG. 2, the inlet section 12 may also include a silencer 48 positioned downstream of the filter housing 44. The silencer 48 may include various baffles, panels, acoustic insulation packets, and/or other devices for attenuating the intensity of at least a portion of the sound generated by the compressor 14. A transition piece 50 may couple the silencer 48 and the filter housing 44. Some embodiments of the inlet section 12 may not include the silencer 44.

The inlet section 12 may further include a duct 52 that fluidly couples the filter housing 44 or the silencer 48 to the compressor 14. In this respect, the duct 52 receives the air 26 from the silencer 48 and/or the filter housing 44 and supplies the air 26 to the compressor 14. A second support structure 54 may support the duct 52 above the base surface 42. As shown, the second support structure 54 is separate from the first support structure 46. Although, the first and second support structures 46, 54 may be portions of a single structure in other embodiments. The duct 52 may include various duct segments, such as an elbow segment 56, a vertically-extending segment 58, a transition segment 60, and an inlet plenum segment 62. In alternate embodiments, however, the duct 52 may include any suitable type and/or number of duct segments. In this respect, the duct 52 may have any suitable configuration extending from the filter housing 44 or the silencer 48 to the compressor 14.

The inlet section 12 also includes a damper 64, which may be operable to control the flow of the air 26 entering the inlet section 12 of the gas turbine engine 10. In this respect, the damper 64 may be positioned at an entrance 66 of the inlet section 12, such as at an axially upstream end of the filter housing 44. In alternate embodiments, however, the damper 64 may be positioned in other suitable locations within the inlet section 12.

As shown in FIG. 3, the damper 64 includes an actuator 68 and one or more adjustable restrictions 70. In particular, the actuator 68 moves the restrictions 70 between two or more positions. Any suitable combination of gears, sprockets, chains, linkages, or other components may transmit motion from the actuator 68 to the restrictions 70. The restrictions 68 may adjust the flow of the air 26 entering the inlet section 12 based on the position thereof. For example, the restrictions 68 may adjust the pressure drop, flow direction, or other characteristics of the air 26. In this respect, the restrictions 70 may be impermeable to air and other fluids. As will be discussed in greater detail below, the flow of the air 26 into the gas turbine engine 10 may be regulated based on the position of the restrictions 70.

In the exemplary embodiment shown in FIG. 3, the restrictions 70 of the damper 64 are a plurality of louvers 72. In this respect, the actuator 68 adjusts the angular orientation of the louvers 72. As shown, a linkage 74 couples the actuator 68 (e.g., a pneumatic or hydraulic cylinder, an electric motor, etc.) to each of the louvers 72. During operation of the damper 64, the actuator 68 moves the various links of the linkage 74 to rotate the louvers 72. The louvers 72 may have a flat plate-like shape, airfoil-like shape, or other suitable shape or configuration. In alternate embodiments, the restrictions 70 may be guillotine doors, diverters, butterfly valves, poppets, irising orifices, or any other suitable type of restriction. Furthermore, the damper 64 may be any suitable structure or device that may adjustably control the flow of the air 26 into the gas turbine engine 10.

Referring again to FIG. 1, the gas turbine engine 10 may include various sensors. As shown, for example, the gas turbine engine 10 may include a load sensor 76, a temperature sensor 78, a relative humidity sensor 80, a precipitation sensor 82, a particulate sensor 84, a filter element differential pressure sensor 85, and a fuel flow sensor 66. In alternate embodiments, however, the gas turbine engine 10 may include only some of the sensors 76, 78, 80, 82, 84, 85, 86 or none of the sensors 76, 78, 80, 82, 84, 85, 86. Furthermore, the gas turbine engine 10 may include other sensors in addition to or lieu of the sensors 76, 78, 80, 82, 84, 85, 86.

The load sensor 76 that detects a load on the gas turbine engine 10. In the embodiment shown in FIG. 1, the load on the gas turbine engine 10 is the generator 24. In this respect, the load sensor 76 may be operatively associated with the generator 24. As such, the load sensor 76 may be an ammeter that detects the amount of electricity produced by the generator 24. In alternate embodiments, the load sensor 76 may be operatively associated with the shaft 22. In this respect, the load sensor 76 may be a Hall Effect sensor that detects a rotational speed of the shaft 22. The rotational speed of the shaft 22 may be used to determine the load of the gas turbine engine 10. Nevertheless, the load sensor 76 may be any suitable sensor for detecting the load on the gas turbine engine 10.

The temperature sensor 78 detects a temperature of the air 26 entering the inlet section 12. In this respect, the temperature sensor 78 is exposed to the air 26 entering the inlet section 12. The temperature sensor 78 may be a thermistor, thermocouple, or any other suitable type of temperature sensor.

The relative humidity sensor 80 detects a relative humidity of the air 26 entering the inlet section 12. In this respect, relative humidity sensor 80 exposed to the air 26 entering the inlet section 12. The relative humidity sensor 80 may be a capacitive relative humidity sensor, a resistive relative humidity sensor, a thermal conductivity relative humidity sensor, or any other suitable type of relative humidity sensor.

The precipitation sensor 82 detects the presence of precipitation (e.g., rain, snow, etc.) proximate to the gas turbine engine 10. In this respect, the precipitation sensor 82 is positioned external to the gas turbine engine 10 and is exposed to ambient conditions. The precipitation sensor 82 may be a tipping bucket rain gauge, a conductivity precipitation sensor, a hygroscopic disk precipitation sensor, or any other suitable type of precipitation sensor.

The particulate sensor 84 detects the presence and/or amount of particulates (e.g., dust) in the air 26 entering the inlet section 12. In this respect, particulate sensor 84 is exposed to the air 26 entering the inlet section 12. The relative particulate sensor 84 may be an optical particulate sensor or any other suitable type of particulate sensor.

The filter element differential pressure sensor 85 detects a difference between the pressure of the air 26 upstream of the filter elements in the inlet section 12 and the pressure of the air 26 downstream of the filter elements. In this respect, the filter element differential pressure sensor 85 is operably coupled to the inlet section 12. In particular, the filter element differential pressure sensor 85 may be position within the filter housing 44 such that it is exposed to the air 26 both upstream of the filter element and downstream of the filter element. The filter element differential pressure sensor 85 may be a pneumatic differential pressure transmitter, an electronic differential pressure transmitter, or any other suitable type of differential pressure sensor.

The fuel flow sensor 86 detects a flow rate or pressure of the fuel 32 flowing from the fuel supply 34 to the combustors 16. As shown in FIG. 1, the fuel flow sensor 86 is operatively associated with and in fluid communication with the fuel 32 flowing to the combustors 16. For example, the fuel flow sensor 86 may be an orifice meter, a turbine flowmeter, a vortex flowmeter, or any other suitable type of fuel flow sensor.

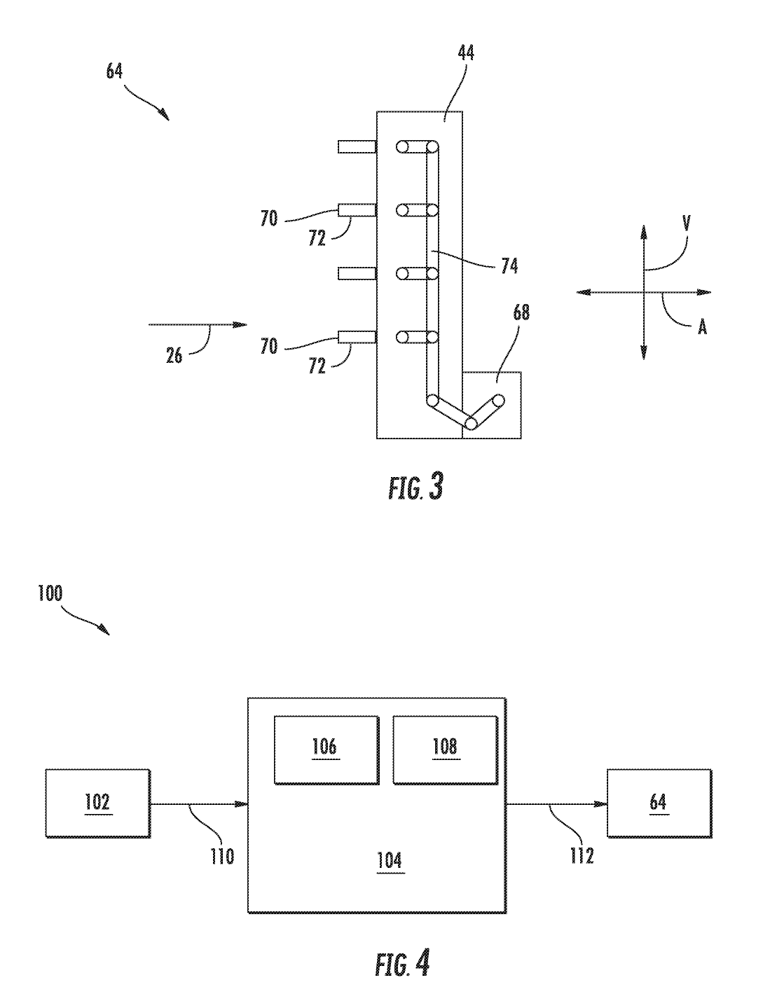

FIG. 4 illustrates a system 100 for regulating the flow of the air 26 into the gas turbine engine 10 in accordance with embodiments of the present disclosure. As will be discussed in greater detail below, the system 100 controls the position of the restrictions 70 of the damper 64 to regulate the flow of the air 26 based on a current operating condition of the gas turbine engine 10.

As shown, the system 100 may include a sensor 102 for detecting an operating parameter of the gas turbine engine 10. The operating parameter may be associated with or is indicative of the current operating condition of the gas turbine engine 10. For example, the operating parameter may be the load on the gas turbine engine 10, the temperature of the air 26, the relative humidity of the air 26, the presence of precipitation, the presence or amount of particulates in the air 26, the filter element different pressure of the air 26, or the flow rate or pressure of the fuel 32. In this respect, the sensor 102 may correspond to the load sensor 76, the temperature sensor 78, the relative humidity sensor 80, the precipitation sensor 82, the particulate sensor 84, filter element differential pressure sensor 85, or the fuel flow sensor 86. Although only one sensor 102 is shown in FIG. 4, the system 100 may include more sensors. In alternate embodiments, the sensor 102 may correspond to sensors not shown in FIG. 1. Furthermore, the operating parameter may be any suitable parameter that corresponds to a current condition within the gas turbine engine 10 or an environmental condition experienced by gas turbine engine 10.

The system 100 also includes a controller 104 communicatively coupled to one or more components of the system 100 and/or the gas turbine engine 10, such as the sensor 102 and the damper 64. The controller 104 may also be communicatively coupled to any other sensors included in the system 100. In certain embodiments, the controller 104 may correspond to a turbine controller (not shown) of the gas turbine engine 10. Alternately, the controller 104 may be a separate processing device of the gas turbine engine 10 in addition to the turbine controller.

In general, the controller 104 may comprise any suitable processor-based device known in the art, such as a computing device or any suitable combination of computing devices. In this respect, the controller 104 may include one or more processor(s) 106 and associated memory device(s) 108 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 108 of the controller 104 may generally comprise memory element(s) including computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 108 may generally be configured to store suitable computer-readable instructions that, when executed by the processor(s) 106, cause the controller 104 to perform various computer-implemented functions, such as one or more aspects of the method 200 described below with reference to FIG. 9. In addition, the controller 104 may also include various other suitable components, such as a communications circuit or module, one or more input/output channels, a data/control bus, and/or the like.

As indicated above, the controller 104 is communicatively coupled to the sensor 102, e.g., via a wired or wireless connection. In this respect, the sensor 102 may transmit measurement signals 110 associated with the operating parameter to the controller 104. The controller 104 may then be configured to determine the current operating condition of the gas turbine engine 10 based on the measurement signals 110 received from the sensor 102. For example, the controller 104 may include a look-up table, suitable mathematical formula, or other logic stored within its memory 108 that correlates the operating parameter measurements to the current operating condition of the gas turbine engine 10. In some embodiments, the current operating condition of the gas turbine engine 10 may be based on multiple operating parameters in embodiments of the system 100 having multiple sensors. In further embodiments, the controller 104 may also receive the current operating condition of the gas turbine engine 10 based on user-inputted settings or signals received from a user interface (not shown) or other user controls.

The controller 104 may also be communicatively coupled to the damper 64, e.g., via a wired or wireless connection. In this respect, the controller 104 may transmit control signals 112 to the damper 64. The control signals 112 indicate the position to which the actuator 68 should move the restrictions 70. As will be discussed in greater detail below, the controller 104 may generate the control signals 112 based on the current operating condition of the gas turbine engine 10.

The controller 104 is configured to control the position of the restrictions 70 to regulate the flow of the air 26 into the inlet section 12 based on the current operating condition of the gas turbine engine 10. For example, upon determining the current operating condition, the controller 104 may be configured to compare the current operating condition to a previous operating condition (i.e., the operating condition of the gas turbine engine 10 before the current operating condition was determined). When the current operating condition is different than the previous operating condition, the characteristics of the air 26 entering the inlet section 12 may be undesirable. In such instances, the controller 104 may be configured to control (e.g., via the control signals 112) the position of the restrictions 70 such that characteristics of the air 26 entering the inlet section 12 are modified. When the current operating condition is the same as the previous operating condition, the characteristics of the air 26 entering the inlet section 12 may be desirable. In such instances, the controller 104 may be configured to control (e.g., via the control signals 112) the position of the restrictions 70 such that characteristics of the air 26 entering the inlet section 12 remain the same.

The embodiment of the damper 64 shown in FIGS. 3 and 5-8, the restrictions 70 are a plurality of louvers 72. In this respect, the actuator 68 adjusts the angular orientation of the louvers 72 to modify various characteristics (e.g., pressure drop and flow direction) of the air 26 entering the inlet section 12. FIGS. 3 and 5-8 illustrate various angular orientations of the louvers 72 that may be associated with various operating conditions of the gas turbine engine 10. The controller 104 may be configured to move the louvers 72 into some, all, or none of the angular orientations described below. Furthermore, the controller 104 may be configured to move the louvers 72 into different angular orientations than the orientations described below.

FIG. 3 illustrates the louvers 72 in a normal operating position. As shown, the louvers 72 have a generally horizontal orientation in the normal operating position. That is, the forward end and the aft end of each louver 72 are positioned at the same vertical position above the base surface 42. This orientation of the louvers 72 may minimize the pressure drop occurring as the air 26 enters the inlet section 12, thereby maximizing the performance of the gas turbine engine 10.

The actuator 68 may move the louvers 72 into the normal operating position when the current operating condition of the gas turbine engine 10 is a normal operating condition. For example, the gas turbine engine 10 may be in the normal operating condition when the gas turbine engine 10 operates under a certain load (e.g., as measured by the load sensor 76) or consumes the fuel 32 as a certain rate (e.g., as measured by the fuel flow sensor 86). When the controller 104 determines that the current operating condition is the normal operating condition, the controller 104 may be configured to send the control signals 112 to the actuator 68. Based on the control signals 112, the actuator 68 may move the louvers 72 into the normal operating position (assuming the louvers 72 are not already in the normal operating position).

FIG. 5 illustrates the louvers 72 in a self-cleaning position. As shown, the louvers 72 have a generally upwardly angled orientation in the self-cleaning position. That is, the forward end of each louver 72 is positioned vertically above the aft end thereof. This orientation of the louvers 72 may create a down flow effect as the air 26 enters the inlet section 12. In this respect, the air 26 to flows diagonally downward through the filters (not shown) in the filter housing 44, thereby improving dust and particulate rejection by the filters.

The actuator 68 may move the louvers 72 into the self-cleaning position when the current operating condition of the gas turbine engine 10 is a self-cleaning operating condition. For example, the current operating condition may be the self-cleaning operating condition when the air 26 entering the inlet section 12 contains a certain amount of dust or other particulates (e.g., as detected by the particulate sensor 84 and/or filter element differential pressure sensor 85). When the controller 104 determines that the current operating condition is the self-cleaning operating position, the controller 104 may be configured to send the control signals 112 to the actuator 68. Based on the control signals 112, the actuator 68 may move the louvers 72 into the self-cleaning position (assuming the louvers 72 are not already in the self-cleaning position).

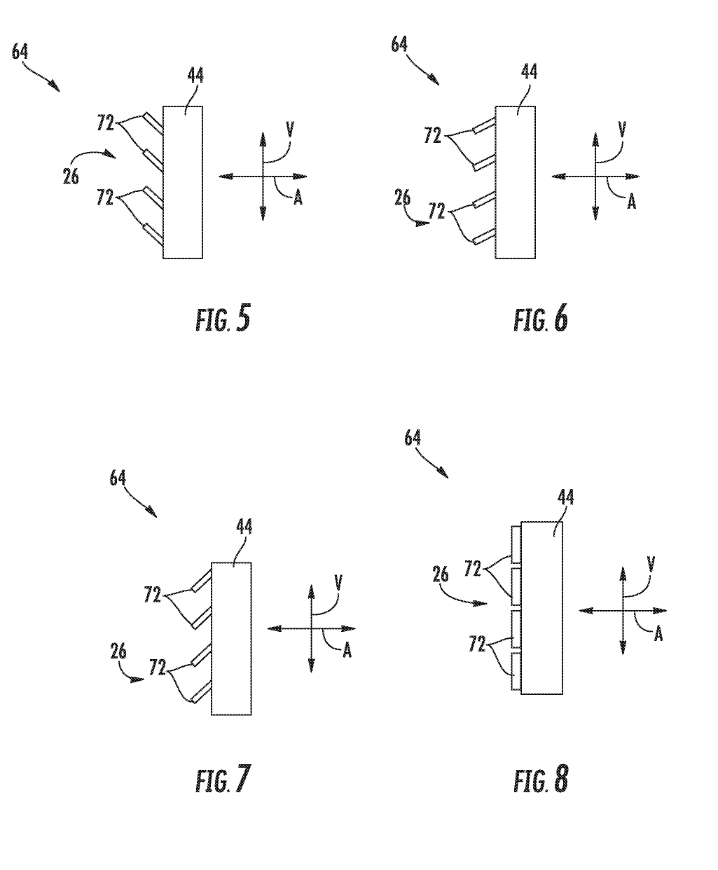

FIG. 6 illustrates the louvers 72 in a weather protection position. As shown, the louvers 72 have a generally downwardly angled orientation in the weather protection position. That is, the forward end of each louver 72 is positioned vertically below the aft end thereof. When in this orientation, the louvers 72 act as a weather hood to reduce the amount of rain, snow, and other precipitation present in the air 26 entering the inlet section 12. Reducing the amount of precipitation ingested by the gas turbine engine 10 lessens the icing and/or wetting of the various filters, screens, cooling coils, moisture separators, and/or other devices in the filter housing 44. Furthermore, the use of the weather protection position supplants the need for a permanent weather hood.

The actuator 68 may move the louvers 72 into the weather protection position when the current operating condition of the gas turbine engine 10 is a precipitation operating position. For example, the current operating condition may be the precipitation operating condition when precipitation is present proximate to the gas turbine engine 10 (e.g., as detected by the relative humidity sensor 80 and/or the precipitation sensor 82). When the controller 104 determines that the current operating condition is the precipitation operating condition, the controller 104 may be configured to send the control signals 112 to the actuator 68. Based on the control signals 112, the actuator 68 may move the louvers 72 into the weather protection position (assuming the louvers 72 are not already in the weather protection position).

FIG. 7 illustrates the louvers 72 in a turndown position. As shown, the louvers 72 have a generally downwardly angled orientation in the turndown position. That is, the forward end of each louver 72 is positioned vertically below the aft end thereof. This orientation of the louvers 72 may create a pressure drop in the air 26 entering the inlet section 12, thereby reducing fuel consumption during periods of turndown (i.e., reduced power output by the gas turbine engine 10). The louvers 72 may have a plurality of turndown positions corresponding to different levels of turndown. In alternate embodiments, the louvers 72 may also have an upwardly angled orientation (i.e., the forward end of each louver 72 is positioned vertically above the aft end thereof) in the turndown position. An upwardly angle orientation may create a similar pressure drop to the downwardly angled orientation shown in FIG. 7. In this respect, both upwardly and downwardly angled orientations of the louvers 72 may create the necessary pressure drop for turndown.

The actuator 68 may move the louvers 72 into the turndown position when the current operating condition of the gas turbine engine 10 is a turndown operating position. For example, the current operating condition may be the turndown operating condition when the gas turbine engine 10 operates under a certain load (e.g., as measured by the load sensor 76) or consumes the fuel 32 as a certain rate (e.g., as measured by the fuel flow sensor 86). When the controller 104 determines that the current operating condition is the turndown operating condition, the controller 104 may be configured to send the control signals 112 to the actuator 68. Based on the control signals 112, the actuator 68 may move the louvers 72 into the turndown position (assuming the louvers 72 are not already in the turndown position).

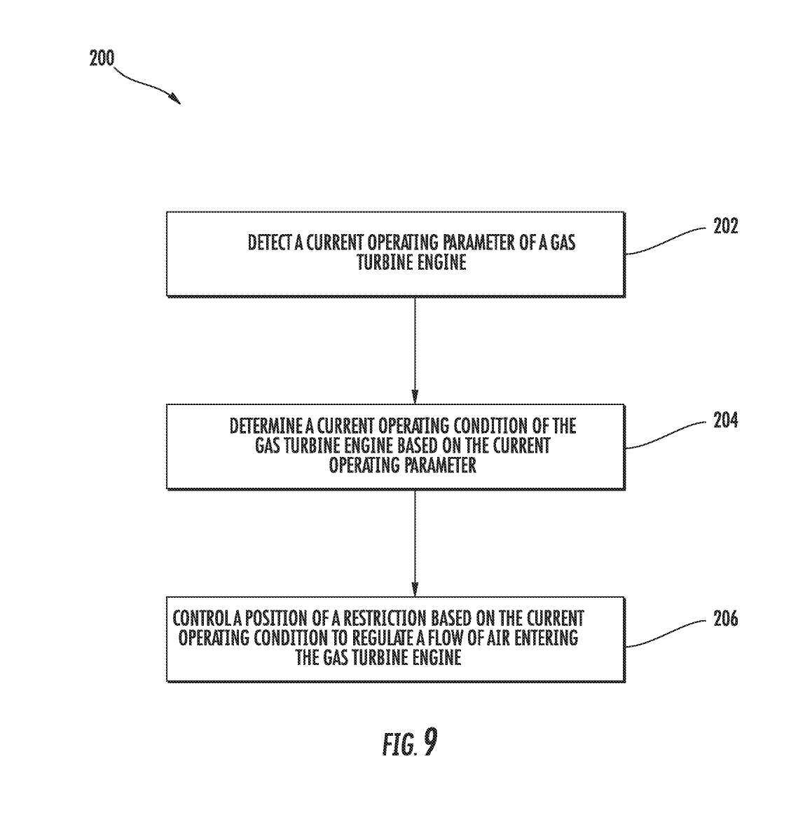

FIG. 8 illustrates the louvers 72 in a shutdown position. As shown, the louvers 72 have a generally vertical orientation in the shutdown position. That is, the forward end and the aft end of each louver 72 are perpendicular to the base surface 42. This orientation of the louvers 72 may generally prevent the air 26 from entering the inlet section 12, thereby reducing condensation on and corrosion of the various components in the inlet section 12. Such condensation and corrosion is typically driven by a stack draft effect.

The actuator 68 may move the louvers 72 into the shutdown position when the current operating condition of the gas turbine engine 10 is a shutdown operating condition. For example, the current operating condition may be the shutdown operating condition when the gas turbine engine 10 operates under no load (e.g., as measured by the load sensor 76) or consumes no fuel 32 (e.g., as measured by the fuel flow sensor 86). When the controller 104 determines that the current operating condition the shutdown operating condition, the controller 104 may be configured to send the control signals 112 to the actuator 68. Based on the control signals 112, the actuator 68 may move the louvers 72 into the shutdown operating position (assuming the louvers 72 are not already in the shutdown position).

The controller 104 may be configured to determine a controlling current operating condition when a plurality of current operating conditions exists. The controlling current operating condition is the current operating condition that the controller 104 uses to control the position of the restrictions 70 when multiple current operating conditions exist. In certain embodiments, the controller 104 may include a look-up table or other logic to determine the controlling current operating condition from the plurality of current operating conditions. For example, the gas turbine engine 10 may simultaneously experience the turndown and self-cleaning operating conditions. In this respect, the controller 104 may use the look-up table to determine that the current operating condition associated with turndown is the controlling current operating condition. In such instances, the controller 104 is configured to control the position of the restrictions based on the turndown operating condition and not the self-cleaning operating condition.

In some embodiments, the restrictions 70 may have a default position, such as the normal operating position shown in FIG. 3. The controller 104 may be configured to send control signals 112 to actuator 68 to move the restrictions 70 from the default position to one or more special positions when certain current operating conditions exist. For example, the special positions may include the self-cleaning position, the weather protection position, the turndown position, and the shutdown position. When the current operating condition corresponding to the special position ceases, the controller 104 may be configured to send control signals 112 to actuator 68 to move the restrictions 70 back to the default position. In this respect, such embodiments do not require detection of operating parameters associated with the default position.

FIG. 9 illustrates a method 200 for regulating the flow of the air 26 entering the gas turbine engine 10 in accordance with embodiments of the present disclosure.

In step 202, a current operating parameter of the gas turbine engine 10 may be detected. For example, the sensor 102 may detect the operating parameter and generate the measurement signals 110 indicative of the operating parameter. As mentioned above, the operating parameter may be the load on the gas turbine engine 10, the temperature of the air 26, the relative humidity of the air 26, the presence of precipitation, the presence or amount of particulates in the air 26, the filter element differential pressure of the air 26, or the flow rate or pressure of the fuel 32.

In step 204, the current operating condition of the gas turbine engine 10 is determined. For example, as indicated above, the controller 104 may be communicatively coupled to the sensor 102. As such, the measurement signals 110 transmitted from the sensor 102 may be received by the controller 104 for subsequent processing of the associated operating parameter measurements. In this respect, the controller 104 may use a look-up table or other logic to determine the current operating condition based on the operating parameter measurements. Furthermore, the controller 104 may determine the current operating condition based on the user input. When multiple current operating conditions exist, the controller 104 may determine a controlling current operating condition.

In step 206, the positions of the restrictions 70 are controlled based on a current operating condition or controlling current operating condition of the gas turbine engine 10 to regulate the flow of the air 26 entering the gas turbine engine 10. For example, the controller 104 may be configured to control the position of the restriction 70. More specifically, the controller 104 may send control signals 112 to the actuator 68 to adjust the position of the restriction 70. In this respect, the actuator 68 may move the restriction 70 to the normal operating position when the current operating condition is the normal operating condition. The actuator 68 may also move the restriction 70 to the self-cleaning position when the current operating condition is the self-cleaning operating condition. The actuator 68 may further move the restriction 70 to the weather protection position when the current operating condition is the precipitation operating condition. The actuator 68 may also move the restriction 70 to the turndown position when the current operating condition is the turndown operating condition. Furthermore, the actuator 68 may move the restriction 70 to the shutdown position when the current operating condition is the shutdown operating condition. In some embodiments, the actuator 68 may move the restriction 70 from a default operating position (e.g., the normal operating position) to special operating position (e.g. the turndown position).

As discussed in greater detail above, the system 100 and the method 200 disclosed herein adjustably regulate the flow of the air 26 entering the gas turbine engine 10 by adjusting the position of the restrictions 70. In this respect, the pressure drop, flow direction, and other characteristics of the air 26 flowing into the inlet section 12 may be optimized based on the current operating condition of the gas turbine engine 10. Conventional systems and methods, however, regulate the flow of air entering gas turbine engines using fixed (i.e., non-adjustable) components, such as weather hoods. As such, conventional systems and methods do not permit optimization of the flow of air entering the gas turbine engine based on the current operating condition thereof.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for regulating a flow of air into a turbomachine, the system comprising:
an inlet section of the turbomachine;
a damper including an actuator and a restriction, the damper being positioned within the inlet section and operable to regulate the flow of air into the turbomachine based on a position of the restriction; and
a controller communicatively coupled to the damper, the controller being configured to control the position of the restriction to regulate the flow of air into the turbomachine based on a current operating condition of the turbomachine.

2. The system of claim 1, wherein the controller is configured to control the actuator to move the restriction to a normal operating position when the current operating condition is a normal operating condition.

3. The system of claim 1, wherein the controller is configured to control the actuator to move the restriction to a self-cleaning position when the current operating condition is a self-cleaning operating condition.

4. The system of claim 1, wherein the controller is configured to control the actuator to move the restriction to a weather protection position when the current operating condition is a precipitation operating condition.

5. The system of claim 1, wherein the actuator moves the restriction to a turndown position when the current operating condition is a turndown operating condition.

6. The system of claim 1, wherein the controller is configured to control the actuator to move the restriction to a shutdown position when the current operating condition is a shutdown operating condition.

7. The system of claim 1, wherein the controller is configured to determine a controlling current operating condition when a plurality of current operating conditions exists, and wherein the controller is configured to control the position of the restriction to regulate the flow of air into the turbomachine based on the controlling current operating condition.

8. The system of claim 1, further comprising:
a sensor communicably coupled to the controller, the sensor being operable to detect an operating parameter of the turbomachine indicative of the current operating condition.

9. The system of claim 8, wherein the controller is configured to control the actuator to move the restriction from a default operating position to a special operating position based on the current operating condition.

10. The system of claim 8, wherein the sensor is a relative humidity sensor, a precipitation sensor, a temperature sensor, a filter element differential pressure sensor, or a particulate sensor.

11. The system of claim 1, wherein the restriction comprises a plurality of louvers.

12. The system of claim 1, wherein the restriction is impermeable.

13. A method for regulating a flow of air into a turbomachine, the method comprising:
controlling, with a controller, a position of a restriction of a damper positioned within an inlet section of the turbomachine to regulate the flow of air into the turbomachine based on a current operating condition of the turbomachine, the damper being communicatively coupled to the controller and operable to regulate the flow of air into the turbomachine based on the position of the restriction.

14. The method of claim 13, further comprising:
moving, with the actuator, the restriction to a normal operating position when the current operating condition is a normal operating condition.

15. The method of claim 13, further comprising:
moving, with the actuator, the restriction to a self-cleaning position when the current operating condition is a self-cleaning operating condition.

16. The method of claim 13, further comprising:
moving, with the actuator, the restriction a weather protection position when the current operating condition is a precipitation operating condition.

17. The method of claim 13, further comprising:
moving, with the actuator, the restriction to a turndown position when the current operating condition is a turndown operating condition.

18. The method of claim 13, further comprising:
moving, with the actuator, the restriction to a shutdown position when the current operating condition is a shutdown operating condition.

19. The method of claim 13, further comprising:
detecting, with a sensor communicably coupled to the controller, an operating parameter of the turbomachine;
determining, with the controller, the current operating condition based on the operating parameter;
determining, with the controller, a controlling current operating condition when a plurality of current operating conditions exists; and
controlling, with the controller, the position of the restriction to regulate the flow of air into the turbomachine based on the controlling current operating condition.

20. The method of claim 13, further comprising:
moving, with the actuator, the restriction from a default operating position to a special operating position based on the current operating condition.
